(19) United States
(12) Patent Application Publication
(10) Pub. No.: US 2006/0176148 A1
(43) Pub. Date: Aug. 10, 2006

(54) Closing system and method for operating the same

(75) Inventor: Frank Sommer, Kirchheim (DE)

Correspondence Address: VENABLE LLP, P.O. BOX 34385, WASHINGTON, DC, 20045-9998, US

(73) Assignee: Sommer Antriebs-und Funktechnik GmbH, Kirchheim (DE)

(21) Appl. No.: 10/549,111

(22) PCT Filed: Mar. 4, 2004
(86) PCT No.: PCT/EP04/02162

§ 371 Date: Sep. 14, 2005

(30) Foreign Application Priority Data
Mar. 27, 2003 (DE) 103 13 710.6

(51) Int. Cl. G05B 19/00

(52) U.S. Cl. 340/5.64; 340/5.7

(57) ABSTRACT

The invention relates to a closing system (1), comprising a transmitter/receiver unit for the non-contacting operation of a door (2) or a gate, as well as to a method for its operation. In order to operate a door (2) or a gate, a transmitting code is transmitted by an authorized transmitter (3) to the receiver (4). The authorized receivers (3) are defined in that their transmitting codes can be read into the receiver (4) by means of a teach-in mode. The receiver (4) can be switched to the teach-in mode upon receiving an identification code from a freely selectable transmitter (3) if the number of transmitting codes for authorized transmitters (3), stored in the receiver (4), is below the limit value (N_{G}) predetermined for the receiver (4). The receiver (4) can be switched to the teach-in mode only upon receiving an identification code from an authorized transmitter (3) if the number of transmitting codes of authorized transmitters (3) that are stored in the receiver (4) corresponds to the limit value (N_{G}).

The invention relates to a closing system, as well as a method for operating said system.

A closing system of this type is known from reference DE 36 25 555 C2. The closing system comprises a transmitter/receiver unit for the remote operation of a garage door by means of at least one transmitter and one receiver. The receiver is provided with a programming switch, a memory for storing transmitting codes, and a microprocessor for comparing a signal received by the receiver to the content of the memory and, if these coincide, for operating the garage door. The system is provided with several transmitters, wherein each transmitter is assigned an individual code belonging to it. The memory comprises a number of storage locations that correspond at least to the number of transmitters. The receiver is provided with a storage location selection switch, wherein during the programming of the system, the respective storage location to be occupied is selected via the storage location selection switch and is occupied by the code for the respective transmitter. For the system operation, a signal picked up by the receiver is compared by the microcomputer to the content of one of the storage locations in the memory in order to determine whether they coincide.

The system makes it possible to use one transmitter for operating several garage doors, but also for one garage door to be operated by means of several transmitters.

The disadvantage of this system is that the programming switch as well as the storage location selector switch on the receiver must be activated for storing the transmitting codes in the receiver.

This causes problems for the operation of the transmitter/receiver unit, in particular if the receiver is installed at a hard to reach location near the garage door.

The receiver furthermore has the disadvantage that optional transmitting codes can be read into it and can also be deleted from it. The system therefore has an undesirably low degree of protection against manipulation.

A different closing system provided with a transmitter/receiver unit for operating doors and gates is known from reference DE 198 21 998 A1. To permit an uncontrolled duplicating of authorization codes on the one hand and, on the other hand, if desired a single duplicating of this authorization code, the closing system utilizes at least three types of signal codes as authorization codes, namely freely copied normal codes, safety codes which can only be copied once, and copied safety codes which cannot be copied again. During a teach-in operation for programming in a new authorization code, the normal components used in the closing system (standard transmitters) can distinguish which signal code is respectively present. For this, the signal codes are provided with identifications which are modified, if necessary, during the teach-in. Safety codes can be transmitted only by means of a special programming device (safety transmitter) that comprises the original identification for the safety code. The identification is changed when the safety code is copied. A teach-in operation with such a copied safety code is refused.

Such a closing system has a higher protection against manipulation because a door or gate can be operated only by means of a standard transmitter for which the authorization code is stored in a predetermined copied state in the receiver of the transmitter/receiver unit. The disadvantage of the system is that separate units are required for programming authorized standard transmitters, namely programming devices designed as safety transmitters. Apart from the fact that this is connected to undesirably high costs for the closing system, the closing system designed in this way is also difficult to handle since the programming device must be installed at a location of the door or gate region that is protected against theft.

It is the object of the present invention to provide a closing system of the aforementioned type which is easy to handle and flexible on one hand and, on the other hand, is highly protected against manipulation.

This object is solved with the features disclosed in claims 1 and 10. Advantageous embodiments and useful modifications of the invention are described in the dependent claims.

The closing system according to the invention comprises a transmitter/receiver unit for the non-contacting operation of a door or gate. To operate the door or gate, a transmitting code is transmitted by an authorized transmitter to the receiver of the transmitter/receiver unit, wherein authorized transmitters are defined as those for which the transmitting codes can be read into the receiver by means of a teach-in mode. The receiver can be switched to the teach-in mode upon receiving an identification code emitted by a freely selectable transmitter if the number of transmitting codes stored in the receiver is lower than a limit value preset in the receiver. If the number of transmitting codes for authorized transmitters stored in the receiver corresponds to the limit value, the receiver can be switched to the teach-in mode only upon receiving an identification code emitted by an authorized transmitter.

One essential advantage of the closing system according to the invention is that no adjustments are required on the receiver either during the operating phase or during the teach-in phase. The receiver consequently can also be installed at inaccessible locations such as in the frame of a door.

Another essential advantage of the closing system according to the invention is that it comprises a maximum number of authorized transmitters for activating the teach-in mode, thereby making it easy to achieve a high protection against manipulation of the closing system.

During an initial state, in which no transmitter has been read into the receiver, the user can select an optional transmitter for switching the receiver to the teach-in mode by transmitting an identification code from the transmitter to the receiver. As soon as the receiver is in the teach-in mode, this transmitter or any other transmitter can be input into the receiver by reading its transmitting code into the receiver. The start and the end of the teach-in mode are preferably indicated by corresponding individual acoustic signals which are emitted by the receiver.

This teach-in process can be repeated with optional transmitters, until the number of transmitters read into the receiver corresponds to the predetermined limit value.

For the subsequent input of other transmitters into the receiver, the teach-in mode can only be activated by the transmitters already stored in the receiver.

That is to say, additional outside transmitters can no longer switch the receiver to the teach-in mode, thus providing efficient protection against manipulations.

Since the authorized transmitters are defined only by the fact that their transmitting codes are stored in the receiver, they can be selected optionally from among a plurality of traditional transmitters.

It is particularly advantageous if the number of transmitters purchased form a set that corresponds to the limit value for transmitters preset in the receiver, wherein these transmitters are read into the receiver either at the factory level or at the specialty store, prior to delivery of the closing system to the end user.

The end user thus can be assured that the purchased closing system can be switched to the teach-in mode only by the transmitters supplied with the system, but not by system-external transmitters.

The end user can repeatedly start a teach-in mode with these system transmitters and can read new transmitters into the receiver, thus changing these transmitters to authorized transmitters. The end user thus can purposely expand and specify the number of authorized transmitters corresponding to the limit value preset in the receiver, wherein the teach-in mode in all cases can only be started by these authorized transmitters. That is to say, the end user is ensured that the receiver cannot be switched to the teach-in mode by system-external transmitters.

In the same way as new transmitters can be read into the receiver, transmitting codes can be deleted from the receiver by means of optional transmitters, but only as long as the number of authorized transmitters stored in the receiver is lower than the preset limit value.

The invention is explained in the following with the aid of drawings, which show in:

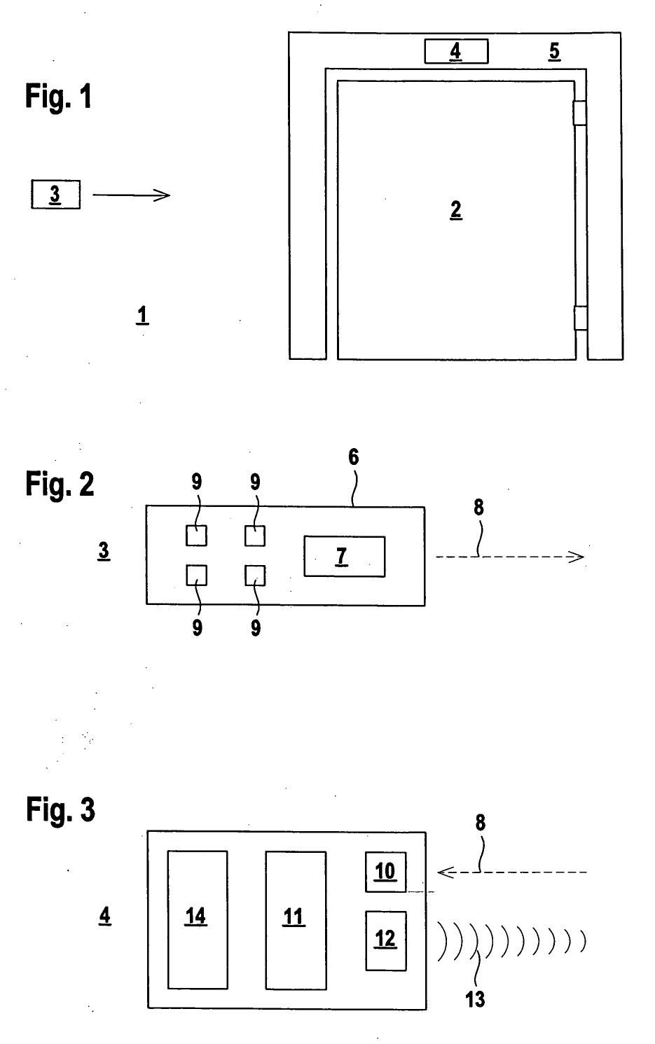

FIG. 1: A schematic representation of a closing system for the non-contacting-operation of a door;

FIG. 2: A schematic representation of a transmitter for the closing system shown in FIG. 1;

FIG. 3: A schematic representation of the receiver for the closing system shown in FIG. 1;

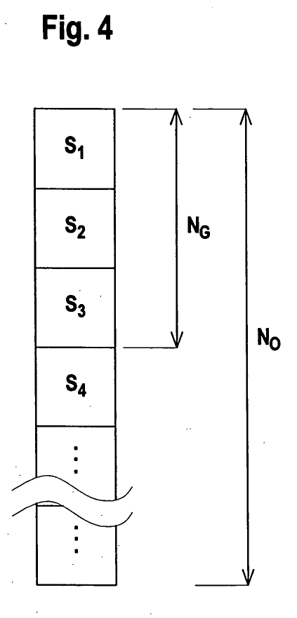

FIG. 4: An example of an occupied storage location inside the receiver according to FIG. 3.

FIG. 1 schematically shows a closing system 1 for the non-contacting operation of a door 2. In place of a door 2, a standard door such as a garage door, for example, can also be operated with the closing system 1.

The closing system 1 comprises a transmitter/receiver unit provided with several transmitters 3, wherein only one of these transmitters 3 is shown in FIG. 1, as well as a receiver 4 that is assigned to the transmitters 3. In the present case, the receiver 4 is integrated into the frame 5 of the door 2.

According to FIG. 2, the transmitters 3 have identical designs. The design for the receiver 4 is shown schematically in FIG. 3.

The transmitter 3 according to FIG. 2 is embodied as hand-held transmitter that is integrated into a casing 6. The transmitter 3 is provided with a radio transmitter module 7 for emitting coded radio signals 8. The transmitter 3 can be activated by means of keys 9, wherein specific key combinations are used to emit predetermined radio signals 8.

The receiver 4 is provided with a radio receiving module 10 for receiving the radio signals 8 from the transmitter 3. The transmitter 3 furthermore comprises a computer unit 11 for decoding the radio signals 8 from the transmitter 3. The computer unit 11 furthermore activates an acoustic signal transmitter 12 which emits acoustic signals 13 in response to the radio signals emitted by the transmitters 3.

Finally, the receiver 4 is provided with a storage unit 14 for storing codes which are transmitted with the radio signals 8 emitted by the transmitters 3 and which can be received and decoded in the receiver 4.

A predetermined number of transmitting codes from different transmitters 3 can be stored in the storage unit 14 of receiver 4. The number of storage locations in the storage unit and thus also the number of transmitters 3 which can be stored is given the reference No in FIG. 4. The transmitting codes stored in the storage unit 14 are given the references S₁, S₂, S₃, S₄ . . . in FIG. 4.

The door 2 is operated via the receiver 4 if the transmitting code emitted by a transmitter 3 and recorded in the receiver 4 coincides with one of the stored transmitting codes. Typically, up to approximately one hundred different transmitting codes can be stored in the receiver 4.

The transmitting codes for the transmitters 3 are stored in the receiver 4 by means of a teach-in mode. A teach-in mode is generally activated in that an identification code is read by a transmitter 3 into a receiver 4. Upon receiving an identification code, the receiver 4 automatically switches from its normal operation to the teach-in mode and this switch is indicated to the user with an individual acoustic signal 13 emitted by the acoustic signal transmitter 12. The teach-in mode is stopped automatically in the receiver 4 by a respective timing device which is integrated into the computer unit 11. Accordingly, the teach-in mode is automatically stopped if no other reliable radio signal 8 from a transmitter 3 is received within a predetermined time window following the reception of the identification code.

A corresponding combination of keys is depressed at the respective transmitter 3 in order to transmit an identification code. The identification code preferably comprises the transmitting code for the transmitter 3 as well as an additional code predetermined by the combination of keys. Since the identification code contains the transmitting code, the identification code respectively received at the receiver 4 can be allocated to the respective emitting transmitter 3.

A limit value N_{G} is stored as parameter in the receiver 4, wherein this parameter defines a predetermined partial number of the storage locations N_{O} in the storage unit 14. Freely selected transmitters 3 can be read into the receiver 4 during a first teach-in phase, wherein the number of transmitters 3 is predetermined by the limit value N_{G}. The value N_{G}=1 in particular can be specified for the limit value N_{G}, wherein N_{G}=3 for the present case.

Prior to the start of this first teach-in phase, none of the storage locations shown in FIG. 4 for the storage unit 14 is occupied, meaning no transmitting code has been stored in the receiver 4.

Starting with this initial state, a teach-in mode can be started in the receiver 4 with an optional transmitter 3 by reading the identification code for this transmitter 3 into the receiver 4.

As soon as the teach-in mode is activated in the receiver 4, a transmitting code can be read into the receiver 4 by means of this transmitter 3, or any other transmitter 3. This transmitting code S₁ is stored in the storage unit 14 of the receiver 4, thereby entering this transmitter 3 into the receiver 4 as the first authorized transmitter 3.

The procedure is repeated for reading in the second and third authorized transmitter 3, wherein the teach-in mode for the input of the second as well as the third authorized transmitter 3 is again activated by means of an identification code transmitted by an optional transmitter 3.

Once the first three storage locations in the storage unit 14 are occupied by the transmitting codes S₁, S₂, S₃, the computer unit 11 records the fact that a total number N_{G} of authorized transmitters 3 was read into the receiver 4.

This is followed by an automatic change in the operating mode in the receiver 4, thus ending the first teach-in phase. Accordingly, a teach-in mode for the input of additional transmitting codes S₄, S₅ . . . can be activated in a following second teach-in phase, but only by an authorized transmitter 3, meaning a transmitter 3 for which the transmitting code was previously stored in the receiver 4. Other transmitters 3, however, can no longer trigger a teach-in mode in the receiver 4.

Prior to the start of the first teach-in mode during the second teach-in phase, only three transmitters 3 have been read into the receiver 4, corresponding to the limit value N_{G}. Consequently, only these three transmitters 3 for which the transmitting codes S₁, S₂, and S₃ are stored in the receiver 4 are authorized transmitters 3 which can be used to start the first teach-in mode. If the transmitting code S₄ of a fourth transmitter 3 is read in by means of this teach-in mode, then said transmitter 3 also becomes an authorized transmitter 3. As a result, a subsequent additional teach-in mode can be triggered not only with the first three transmitters 3, for which the transmitting codes S₁, S₂, and S₃ were read during the first teach-in phase into the receiver 4, but also with the fourth transmitter 3 that is read in. The user can repeatedly start a teach-in mode, using only the previously read in transmitters 3, in order to input new transmitters 3 into the receiver 4. In this way, the user can define authorized transmitters 3 for activating a teach-in mode until the value N_{O} is reached.

According to a particularly advantageous embodiment, the transmitter/receiver unit of a closing system 1 is sold in the form of a set, wherein the number of transmitters 3 in this set corresponds to the maximum number N_{G}. These transmitters 3 are recorded in the receiver 4 as authorized transmitters 3 at the factory level, prior to the delivery. The end user is thus ensured that a teach-in mode can be started in the receiver 4 only with the transmitters 3 belonging to the set. Starting with the base set of N_{G} authorized transmitters 3, the end user can subsequently read in additional, optionally selected authorized transmitters 3, up to the value N_{O}.

In general, it is not only possible to read in new transmitting codes from the transmitters 3 during the teach-in mode, but it is also possible to change or delete transmitting codes in the receiver 4.

In principle, individual transmitting codes stored in the receiver 4 can be deleted in a deleting operation.

With the present exemplary embodiment and following the activation of a teach-in mode, a delete command is transmitted in the form of a radio signal 8 from a transmitter 3 to the receiver 4 in order to realize a deleting operation. All transmitting codes stored in the storage unit 14 are then deleted with this delete command. The delete command is triggered by depressing a corresponding combination of keys on the transmitter 3. It is preferable if a deleting operation in the receiver 4 is triggered by an individual acoustic signal 13, emitted by the acoustic signal transmitter 12.

If the receiver 4 is still in the first teach-in phase, meaning the number of authorized transmitters 3 stored in the storage unit 14 of receiver 4 is still below the maximum number N_{G}, the delete operation can be triggered by an optional transmitter 3.

However, once the maximum number N_{G} of authorized transmitters 3 is stored in the receiver 4, the delete operation can be realized only with one of the authorized transmitters 3.

### REFERENCE NUMBER LIST

(1) closing system
(2) door
(3) transmitter
(4) receiver
(5) frame
(6) casing
(7) radio transmitter module
(8) radio signals
(9) keys
(10) radio receiving module
(11) computer unit
(12) signal transmitter
(13) signals
(14) storage unit
N_{O} number of storage locations
N_{G} limit value
S₁ transmitting code
S₂ transmitting code
S₃ transmitting code
S₄ transmitting code

1. A closing system comprising a transmitter/receiver unit for the non-contacting operation of a door or a gate for which a transmitting code is transmitted by an authorized transmitter to the receiver of the transmitter/receiver unit for operating said door or gate and wherein the authorized transmitters are defined as transmitters for which the transmitting codes can be read into the receiver by means of a teach-in mode, characterized in that a limit value (N_{G}) is preset in the receiver (4), that the receiver (4) switches to the teach-in mode upon receiving an identification code emitted by a freely selectable transmitter (3) if the number of transmitting codes emitted by authorized transmitters (3) and stored in the receiver (4) is lower than the limit value (N_{G}), and that the receiver (4) switches to the teach-in mode only upon receiving an identification code that is emitted by an authorized transmitter (3) if the number of transmitting codes for authorized transmitters (3), stored in the receiver (4), corresponds at least to the limit value (N_{G}).

2. The closing system according to claim 1, characterized in that the transmitters (3) emit coded radio signals (8) which can be decoded in the receiver (4).

3. The closing system according to claim 1, characterized in that the identification code for a transmitter (3) comprises its transmitting code.

4. The closing system according to claim 3, characterized in that a predetermined combination of keys (9) can be activated on the transmitter (3) for transmitting an identification code and that the identification code is derived in the transmitter (3) from the transmitting code and the key combination.

5. The closing system according to claim 1, characterized in that the limit value (N_{G}) is predetermined by a corresponding number of storage locations in a storage unit (14) in which respectively one transmitting code for a transmitter (3) can be stored.

6. The closing system according to claim 1, characterized in that an acoustic signal transmitter (12) is integrated into the receiver (4) and functions to generated an individual acoustic signal (13) for acknowledging the change to the teach-in mode.

7. The closing system according to claim 1, characterized in that the teach-in mode is stopped automatically in the receiver (4).

8. The closing system according to claim 7, characterized in that an individual acoustic signal (13) can be generated for signaling the end of a teach-in mode in the receiver (4).

9. The closing system according to claim 1, characterized in that the receiver (4) is integrated into the frame (5) of a door (2).

10. A method for operating a closing system by means of a transmitter/receiver unit as disclosed in claim 1, wherein during an operating phase of the closing system, a transmitting code is transmitted from an authorized transmitter to the receiver of the transmitter/receiver unit for operating a door or a gate, and wherein the authorized transmitters are read into the receiver using a teach-in mode for reading their transmitting codes into the receiver and storing the codes therein, characterized in that the receiver (4) can be switched to the teach-in mode upon receiving an identification code transmitted by means of a freely selectable transmitter (3) if the number of transmitting codes of authorized transmitters (3) stored in the receiver (4) is lower than the limit value (N_{G}) predetermined in the receiver (4), and that the receiver (4) can be switched to the teach-in mode only upon receiving an identification code from an authorized transmitter (3) if the number of transmitting codes for authorized transmitters (3), stored in the receiver 4, corresponds at least to the limit value (N_{G}).

11. The method according to claim 10, characterized in that the identification code for activating the teach-in mode is read by means of a first transmitter (3) into the receiver (4) and that the transmitting code subsequently read into the receiver (4) comes from a second transmitter (3).

12. The method according to claim 10, characterized in that transmitting codes stored in the receiver (4) can be changed with the teach-in mode.

13. The method according to claim 10, characterized in that transmitting codes stored in the receiver (4) can be deleted with the teach-in mode.

14. The method according to claim 13, characterized in that a delete command for deleting transmitting codes is read into the receiver (4) by a transmitter (3).

15. The method according to claim 14, characterized in that all transmitting codes stored in the receiver (4) are deleted with a delete command.

16. The method according to claim 12, characterized in that transmitting codes in the receiver (4) can be changed or deleted only by means of an authorized transmitter (3) if the number of transmitting codes of authorized transmitters (3), stored in the receiver (4), corresponds to the limit value (N_{G}).
